(19) United States
(12) Patent Application Publication
(10) Pub. No.: US 2025/0033360 A1
(43) Pub. Date: Jan. 30, 2025

(54) PRINTING APPARATUS, CONTROL METHOD, AND STORAGE MEDIUM

(71) Applicant: CANON KABUSHIKI KAISHA, Tokyo (JP)

(72) Inventors: TAKATOSHI NAKANO, Kanagawa (JP); TETSUJI SUZUKI, Kanagawa (JP); RYOSUKE ARAKI, Kanagawa (JP)

(21) Appl. No.: 18/778,957

(22) Filed: Jul. 20, 2024

(30) Foreign Application Priority Data
Jul. 26, 2023 (JP) 2023-121676
Oct. 17, 2023 (JP) 2023-178649

(51) Int. Cl. B41J 2/165

(52) U.S. Cl. CPC B41J 2/16552; B41J 2/16532

(57) ABSTRACT

A printing apparatus includes: a cleaning unit including cleaning mechanisms configured to clean a printing head ejecting a liquid, each of the cleaning mechanisms scanning in a predetermined direction while contacting the printing head; a movement mechanism configured to move each of the cleaning mechanisms between a first height in contact with the printing head and a second height not in contact with the printing head; a driving source of the movement mechanism; and a coupling/releasing unit configured to perform coupling/releasing between the driving source and the movement mechanism, in which one or more of the cleaning mechanisms are moved to the first height by the movement mechanism coupled with the driving source, and after the one or more cleaning mechanisms are moved to the first height, the coupling/releasing unit releases coupling between the driving source and the movement mechanism.

### BACKGROUND

### Field

The present disclosure relates to a technique of cleaning a printing head of a printing apparatus.

### Description of the Related Art

Conventionally, there had been known an ink jet printing apparatus as a printing apparatus that prints a character, an image, and the like by ejecting an ink onto a printing medium such as a continuous sheet winding into a roll.

There has been known a problem in the ink jet printing apparatus that the ink ejected from a nozzle in a process of printing a character, an image, and the like floats as mist without landing on the sheet and adheres to the nozzle, which causes a subsequently-ejected ink droplet to be deviated and causes reduction of the image quality.

As a solution to this problem, there has been known a configuration in which an ejection nozzle formation surface is wiped out by a blade having elasticity to recover the ejection nozzle surface to a state before ejection and maintain the ejection performance. However, in a case where adherence of the ink adhering to the nozzle formation surface of an ejection head is high, enough removal force cannot be obtained by wiping out by the blade, and it is necessary to mount a cleaning mechanism with higher removal force than the blade.

Japanese Patent Laid-Open No. 2019-162862 discloses a configuration in which a nozzle surface is cleaned by not only wiping out by a blade but also wiping out by a web. To be specific, there is disclosed a configuration in which a first cleaning mechanism including a blade that wipes out a nozzle surface and a second cleaning mechanism including a web that wipes out the nozzle surface are selectively moved by one driving source to a wipe-out position in which the nozzle surface is wiped out and a retraction position distant from the nozzle surface.

However, in Japanese Patent Laid-Open No. 2019-162862, the driving source for position switching is in a state of being connected constantly to a cleaning mechanism unit including the first cleaning mechanism and the second cleaning mechanism. For this reason, the driving source and a drivingly coupling unit need to be moved together in a case of moving the cleaning mechanism unit to the head for cleaning. Therefore, it is required to secure a region that allows for movement of the cleaning mechanism unit and a unit related to driving of the cleaning mechanism unit together, and the printing apparatus becomes large in size.

Therefore, in light of the above-described problem, an object of the present disclosure is to downsize a printing apparatus.

### SUMMARY OF THE DISCLOSURE

An embodiment of the present invention is a printing apparatus that includes: a cleaning unit including multiple cleaning mechanisms that clean a printing head ejecting a liquid, each of the multiple cleaning mechanisms being able to scan in a predetermined direction while being put in contact with the printing head; a movement mechanism that can move each of the multiple cleaning mechanisms between a first height for contact with the printing head and a second height for no contact with the printing head; a driving source of the movement mechanism; and a coupling/releasing unit that performs coupling/releasing between the driving source and the movement mechanism, in which one or more cleaning mechanisms of the multiple cleaning mechanisms are moved to the first height by the movement mechanism coupled with the driving source, and after the one or more cleaning mechanisms are moved to the first height, the coupling/releasing unit releases coupling between the driving source and the movement mechanism.

Further features of the present invention will become apparent from the following description of exemplary embodiments with reference to the attached drawings.

### BRIEF DESCRIPTION OF THE DRAWINGS

FIG. 1 is a cross-sectional view illustrating an internal configuration of a printing apparatus;

FIG. 2 is a perspective view of a sheet conveyance unit housing of a printing unit;

FIG. 3 is a perspective view of a printing head ascending/descending mechanism;

FIG. 4 is a perspective view of a printing head;

FIG. 5 is a perspective view of a maintenance tray and the printing head positioned in the maintenance tray;

FIGS. 6A to 6C are schematic views illustrating a positioning operation of the printing head to the maintenance tray;

FIGS. 7A and 7B are schematic views illustrating a state in which the maintenance tray and the printing head are distant from each other;

FIGS. 8A and 8B are diagrams illustrating a state in which the positioning operation of the printing head to the maintenance tray is completed;

FIG. 9 is a diagram illustrating the printing head positioned in the maintenance tray;

FIGS. 10A to 10C are schematic views illustrating a cleaning start position of a cleaning liquid application unit;

FIGS. 11A and 11B are schematic views illustrating a cleaning start position of a liquid removal unit;

FIGS. 12A to 12C are schematic views illustrating a cleaning start position of a negative pressure application unit;

FIG. 13 is a schematic view illustrating a state in which a maintenance unit in a first position (a position in which a height can be changed) of a y direction position is retracted from the printing head;

FIG. 14 is a diagram illustrating a cam mechanism of the maintenance unit;

FIG. 15 is a schematic view illustrating a state in which the cleaning liquid application unit in the first position is in a position (a head contact height) in which the cleaning liquid application unit is put in contact with a nozzle formation surface of the printing head;

FIG. 16 is a schematic view illustrating a state in which the liquid removal unit in the first position is at the head contact height;

FIG. 17 is a schematic view illustrating a state in which the negative pressure application unit in the first position is at the head contact height;

FIG. 18 is a schematic view illustrating the maintenance unit in a second position of the y direction position;

FIGS. 19A and 19B are schematic views illustrating a state in which the maintenance unit in the maintenance tray is in the endmost portion of a movable range in a y direction;

FIG. 20 is a perspective view of the maintenance unit in a state of being the farthest in the maintenance tray;

FIG. 21 is a schematic view illustrating a state in which the maintenance unit and a driving source are connected to each other;

FIG. 22 is a schematic view illustrating a state in which the maintenance unit is distant from the driving source;

FIG. 23 is a schematic view illustrating a state in which the liquid removal unit and the cleaning liquid application unit are at the head contact height;

FIGS. 24A and 24B are schematic views illustrating cleaning start states of the liquid removal unit and the cleaning liquid application unit;

FIG. 25 is a flowchart of normal cleaning;

FIG. 26 is a flowchart of normal cleaning (after coated paper printing); and

FIG. 27 is a flowchart of cleaning in a case of ink filling.

### DESCRIPTION OF THE EMBODIMENTS

Embodiments according to the present disclosure are described below with reference to the drawings. Note that, in some cases, elements having the same functions or elements of the same intent in the drawings are provided with the same reference numerals, and descriptions thereof are omitted.

### First Embodiment

### <Configuration of Printing Apparatus>

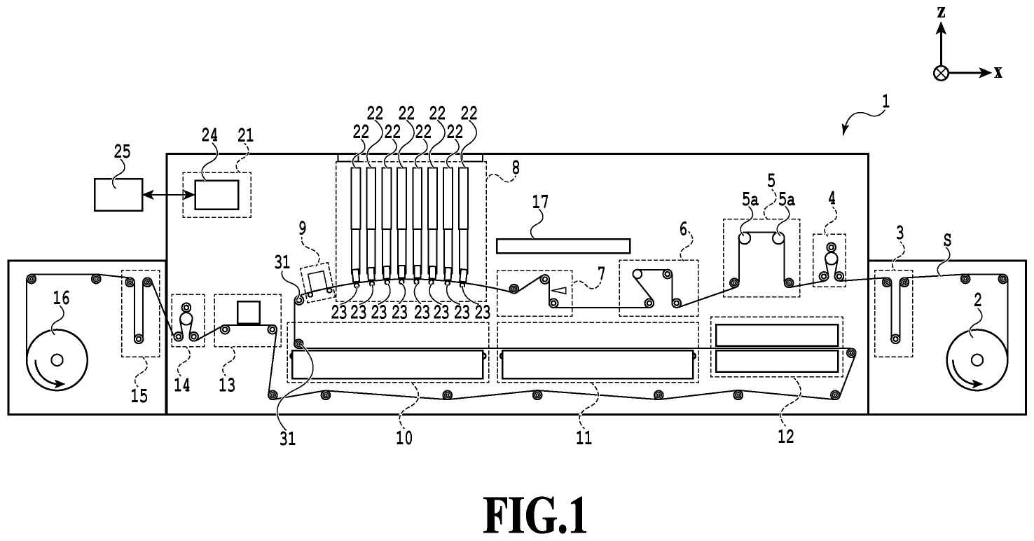

FIG. 1 is a schematic cross-sectional view illustrating an internal configuration of a printing apparatus 1. An up and down direction in FIG. 1 is defined as a “height direction”, a right and left direction in FIG. 1 is defined as a “longitudinal direction”, and a direction orthogonal to the height direction and the longitudinal direction (a direction from near to far from a paper surface in FIG. 1) is defined as a “sheet width direction”. Additionally, hereinafter, the printing apparatus 1 is described as a printer that prints an image on a continuous sheet winding in a roll by using an ink and that is a high-speed line printer capable of high-speed printing.

As illustrated in FIG. 1, the printing apparatus 1 includes units therein, which are a wind-down roll unit 2, a first dancer unit 3, a first main conveyance unit 4, a meandering correction unit 5, a conveyance detection unit 6, a mark sensor unit 7, and a printing unit 8. Additionally, the printing apparatus 1 includes units as subsequent stage units of the printing unit 8, which are a first scanner unit 9, a first dryer unit 10, a second dryer unit 11, a cooler unit 12, a second scanner unit 13, a second main conveyance unit 14, a second dancer unit 15, a wind-up roll unit 16, and a maintenance tray 17. A sheet S is conveyed along a sheet conveyance route indicated by a solid line in FIG. 1, and the above-mentioned units perform processing on the sheet S.

The wind-down roll unit 2 is a unit to hold and supply a continuous sheet winding in a roll. The wind-down roll unit 2 has a configuration to store a wind-down roll and draw out and supply the sheet S. Note that, although the number of the roll that can be stored is one in FIG. 1, the number of the roll that can be stored may not be limited to one, and a configuration in which two or three or more rolls are stored, and the sheet S is alternatively drawn out and supplied from the multiple rolls may be applied.

The first dancer unit 3 is a unit to apply constant sheet tension between the wind-down roll unit 2 and the first main conveyance unit 4. In the first dancer unit 3, sheet tension is applied by a not-illustrated tension application unit.

The first main conveyance unit 4 is a unit to send the sheet S to a subsequent unit and to apply predetermined tension to the sheet in cooperation with the second main conveyance unit 14. The first main conveyance unit 4 is rotated by driving a not-illustrated motor and conveys the sheet S while applying the tension to the sheet S.

The meandering correction unit 5 is a unit to correct meandering in the sheet width direction while conveying the sheet S to which the tension is applied. The meandering correction unit 5 includes a meandering correction roller 5a and a not-illustrated meandering detection sensor that detects meandering of the sheet S. The meandering correction roller 5a can change tilt of the sheet S by a not-illustrated motor and corrects meandering of the sheet S based on a measurement result of the meandering detection sensor. In this process, it is possible to enhance a function of the meandering correction by winding the sheet S around the meandering correction roller 5a. The meandering correction unit 5 can correct the meandering conveyance direction of the sheet S to a regular conveyance direction.

The conveyance detection unit 6 is a unit to detect the tension while conveying the sheet to which the tension is applied between the first main conveyance unit 4 and the second main conveyance unit 14. Additionally, the conveyance detection unit 6 is also a unit to detect a speed of the sheet S to control a printing timing of the printing unit 8.

The mark sensor unit 7 is a unit to detect a mark printed in advance on the sheet S to control the printing timing of the printing unit 8.

The printing unit 8 is a unit to perform printing on the conveyed sheet S, and an image is printed by performing printing processing (specifically, ink ejection processing and the like) by a printing head 22 on the sheet S from above. The conveyance route in the printing unit 8 is formed by multiple guide rollers 23 arranged to form a circular arc shape projecting upward, and a clearance between the guide rollers 23 and the printing head 22 is secured by applying constant tension to the sheet S. In the printing head 22, multiple printing heads are arrayed along the conveyance direction. The printing apparatus 1 of the present example includes eight line type printing heads in total corresponding to four colors, which are Bk (black), Y (yellow), M (magenta), and C (cyan), and additionally a reaction liquid and three special colors. Note that, the number of colors is not limited to four, and the number of the printing heads is not limited to eight. As an ink jet system applied to the printing head 22, a system using a heating element, a system using a piezoelectric element, a system using an electrostatic element, a system using an MEMS element, and the like can be employed. The ink of each color is supplied from a corresponding ink tank (not illustrated) to the printing head 22 via an ink tube.

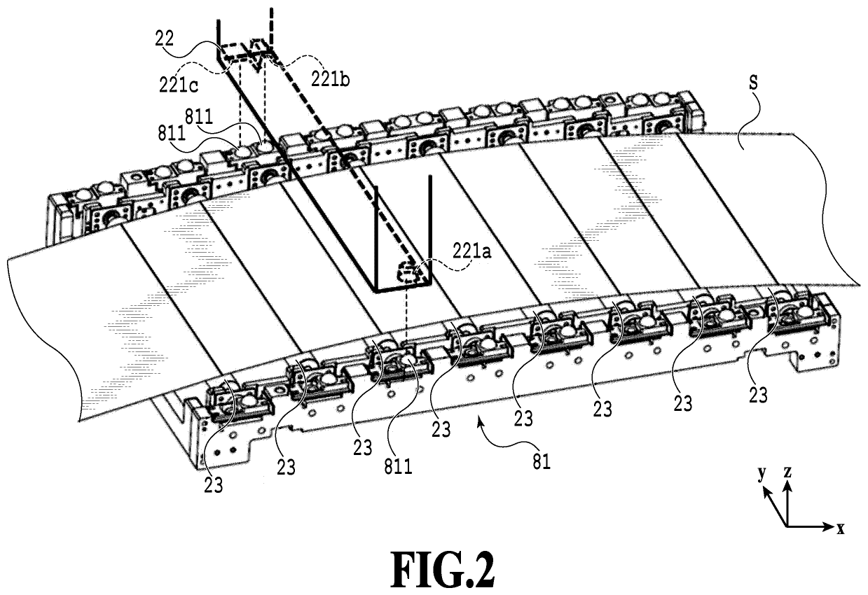

As illustrated in FIG. 2, multiple against-printing-head positioning members 811 to position the printing head are provided to a sheet conveyance unit housing 81 of the printing unit 8. To be specific, three against-printing-head positioning members 811 are provided for one printing head 22. These three against-printing-head positioning members 811 have a relationship of pinching the sheet S in different positions in a y direction, and one is provided on a front side (a −y side) in FIG. 2 while the other two are provided on a rear side (a +y side) in FIG. 2.

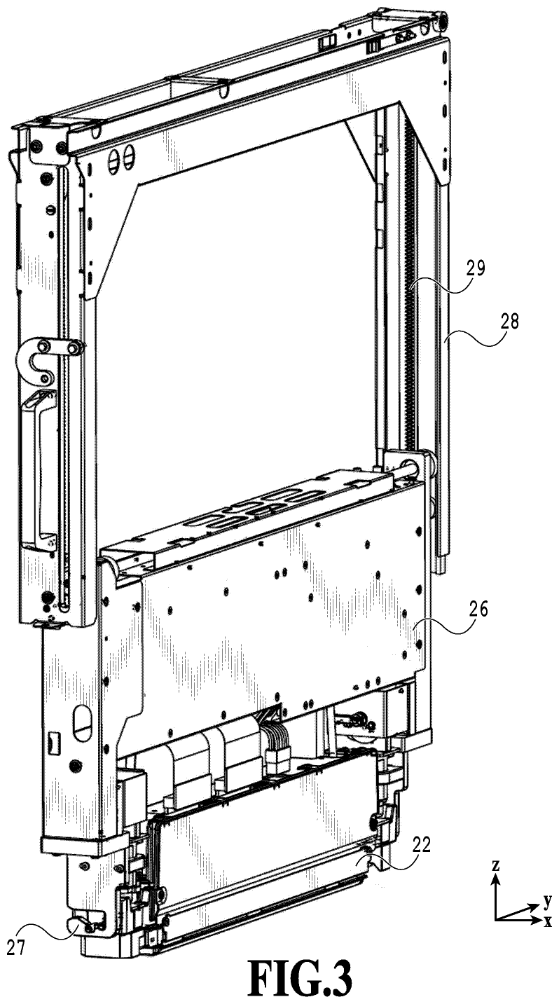

FIG. 3 is a perspective view illustrating an ascending/descending mechanism of the printing head 22. As illustrated in FIG. 3, the printing head 22 is rotatably supported by a printing head holding unit 26 to hold and ascend/descend the printing head 22 upward and downward in the form such that the printing head 22 supports a printing head support shaft 27 from below. The printing head holding unit 26 performs the ascending/descending operation upward and downward along a printing head ascending/descending rail 29 included in a printing head ascending/descending frame 28 by a not-illustrated driving mechanism included inside the printing head holding unit 26.

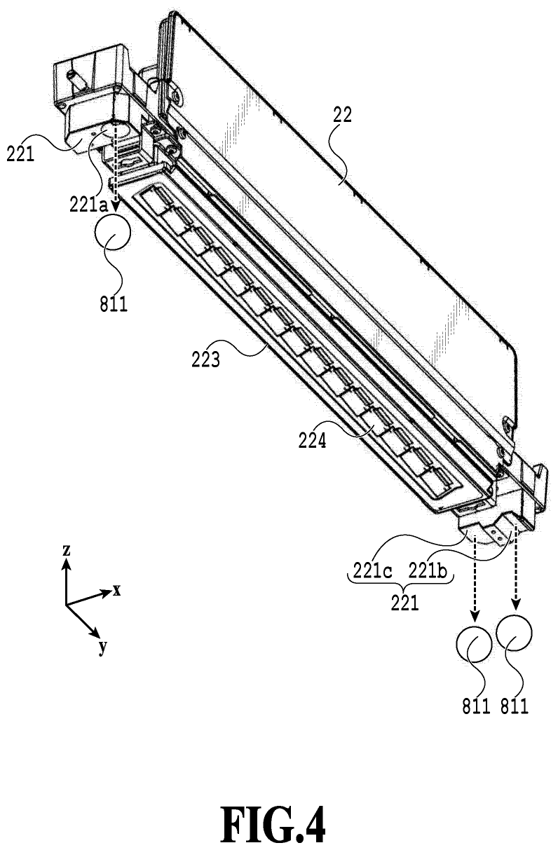

FIG. 4 is a perspective view of the printing head 22 and illustrates a nozzle formation surface 223. Multiple nozzle plates 224 are provided on the nozzle formation surface 223 facing the sheet, and multiple nozzles to eject ink droplets onto the sheet S are provided to each of the multiple nozzle plates 224.

Here, referring back to FIG. 1 again, and the constituents in FIG. 1 are described. The first scanner unit 9 is a unit to read the image printed on the sheet S by the printing unit 8 and to detect misalignment and density of the image. A detection result of the first scanner unit 9 is used for correction and is, for example, used for position correction and color tone correction.

The first dryer unit 10 and the second dryer unit 11 are units to reduce the liquid contained in the ink applied on the sheet S by the printing unit 8 and to enhance the fixability between the sheet S and the ink. The second dryer unit 11 is arranged downstream of the first dryer unit 10 in the sheet conveyance direction. The first dryer unit 10 and the second dryer unit 11 heat the printed sheet S and dry the applied ink. In the first dryer unit 10 and the second dryer unit 11, hot air is applied to the passing sheet S from at least an ink application surface side to dry the ink application surface. Note that, as a drying system, in addition to the system to apply hot air, a system to irradiate a surface of the sheet S with electromagnetic waves (ultraviolet rays, infrared rays, and the like) or a conduction heat transfer system by a contact of a heating device may be combined.

A winding guide roller 31 is a roller that is arranged downstream of the printing unit 8 in the conveyance direction and winds a surface of the sheet S opposite of the ink application surface at a constant winding angle in order to block an effect of the hot air generated in the first dryer unit 10 on the printing unit 8. In the present example, two winding guide rollers 31 are arranged between the first scanner unit 9 and the first dryer unit 10, and the sheet S is turned back so as to be substantially parallel between an upper portion and a lower portion of the apparatus. The first dryer unit 10 is arranged below the printing unit 8, and the second dryer unit 11 is arranged below the conveyance detection unit 6 and the mark sensor unit 7.

The cooler unit 12 cools down the sheet S on which the ink is fixed by the first dryer unit 10 and the second dryer unit 11 to solidify the softened ink and also to suppress a temperature change of the sheet S over steps of the units arranged downstream of the printing apparatus 1 in the conveyance direction. The ink application surface of the sheet S is cooled down by applying wind at a lower temperature than the sheet S from at least the ink application surface side to the sheet S passing through the inside of the cooler unit 12. Note that, a cooling system is not limited to the system to apply wind. A conduction heat transfer system by a contact of a heat dissipation member may be applied, or those systems may be combined.

The second scanner unit 13 is a unit to read a test image printed on the sheet S by the printing unit 8 before the real printing and to detect misalignment and density of the image. A detection result of the second scanner unit 13 is used for correction in the real printing after printing the test image.

The second main conveyance unit 14 is a unit that functions by operating with the first main conveyance unit 4 and is a unit to convey the sheet S while applying the tension to the sheet S and to adjust the tension of the sheet S. The second main conveyance unit 14 is rotated by being driven by a not-illustrated motor. The tension of the sheet S is adjusted by a drivingly coupled clutch (not illustrated) that can control a torque based on a tension value detected by a not-illustrated tension control unit. Note that, as an additional configuration to adjust the tension of the sheet S, a configuration to control a speed of the second main conveyance unit 14 based on a detection result of the conveyance detection unit 6 may be added. As a method of implementing this configuration, either of a torque control method to control the value of the torque transmitted from the clutch and a speed control method to control the roller speed of the second main conveyance unit 14 may be considered. Alternatively, these two methods may be switched and used depending on purpose, or the two methods may be used concurrently.

The second dancer unit 15 is a unit to apply constant tension between the second main conveyance unit 14 and the wind-up roll unit 16. In the second dancer unit 15, a not-illustrated tension application unit applies the constant tension to the sheet.

The wind-up roll unit 16 is a unit to wind up the sheet S subjected to the printing processing around a winding core. Note that, although the number of the collectable roll is one in FIG. 1, the number of the collectable roll is not limited to one, and a configuration in which two or three or more winding cores are included to collect the sheet S by alternatively switching the winding cores may be applied. Note that, depending on the contents of the processing after printing, instead of a configuration to wind up the sheet S around the winding core, a configuration to cut the continuous sheet by using a cutter and to stack the cut sheet S may be applied.

A control unit 21 is a unit taking charge of controlling the units in the printing apparatus 1. The control unit 21 includes a CPU, a storage device, a controller including various control units, an external interface, and an operation unit 24 that allows a user to perform input and output. An operation of the printing apparatus 1 is controlled based on an instruction inputted via the operation unit 24 or an instruction from a host apparatus 25 such as a host computer connected to the controller via the external interface.

The maintenance tray 17 is a unit including a mechanism that recovers the ejection performance of the printing head 22. As such a mechanism, for example, there may be a cap mechanism that protects an ink ejection surface of the printing head 22, a wipe-out mechanism (a so-called wiping mechanism) that wipes out the ink ejection surface by using a blade and the like, a suction mechanism that sucks the ink in the nozzle from the ink ejection surface with a negative pressure, and the like.

### <Configuration of Maintenance Tray>

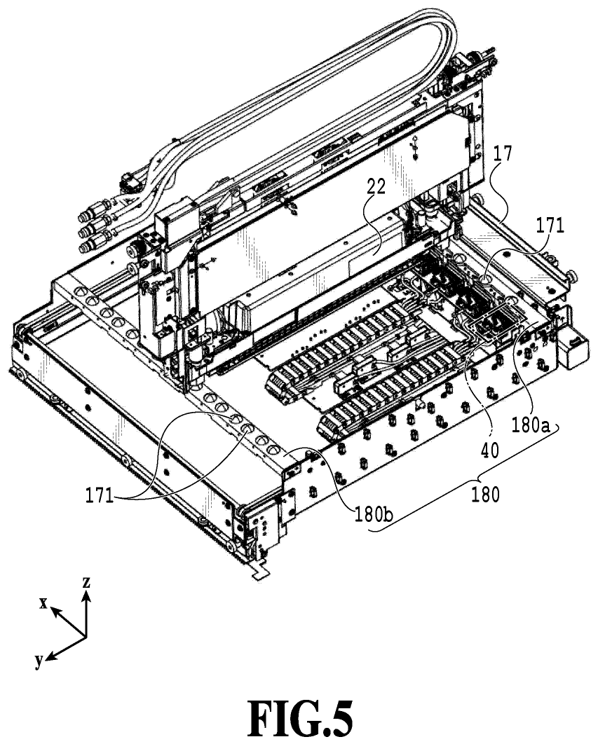

FIG. 5 is a perspective view of the maintenance tray and the printing head positioned in the maintenance tray. As illustrated in FIG. 5, the maintenance tray 17 includes a maintenance unit 40 corresponding to each printing head 22 and multiple against-printing-head positioning members 171 in the shape of a sphere to position the printing head 22 to the maintenance unit 40. The multiple against-printing-head positioning members 171 corresponding to one printing head 22 are arranged in line in an apparatus depth direction (the y direction) inside the maintenance tray 17 and are held by a beam member 180 extending along the sheet conveyance direction (an x direction). In the present example, three balls of the against-printing-head positioning members 171 are required to position each printing head 22 to the maintenance tray 17, and one is arranged on a front side beam 180a in the maintenance tray 17 while the other two are arranged on a rear side beam 180b. Note that, a configuration of ball arrangement used for positioning is not limited thereto, and a configuration including two balls on the front side while one ball is on the rear side may be applied, or a configuration in which one ball is arranged on each of the front side and the rear side while the orientation of the printing head 22 is determined by another portion. Additionally, a configuration for positioning is not limited to the configuration using a positioning member in the shape of a sphere. For example, a configuration in which a part of the printing head 22 is struck to the inside of the maintenance tray 17 or a configuration in which positioning is achieved by using a hole and a pin provided to the maintenance tray 17 and the printing head 22 may be employed.

### <Positioning of Printing Head to Maintenance Tray>

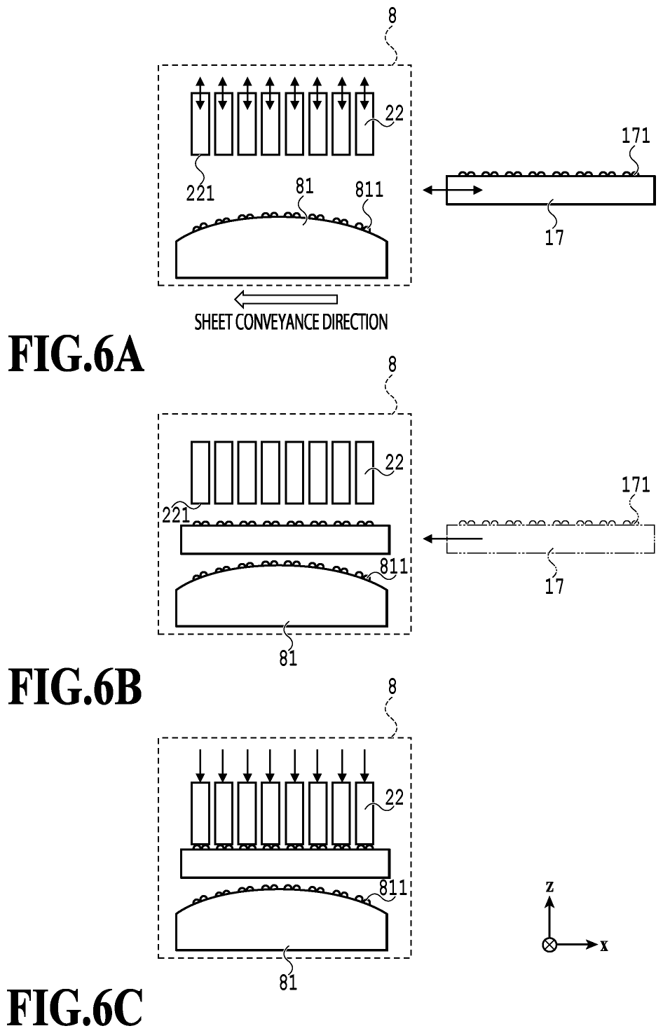

FIGS. 6A to 6C are schematic views illustrating the operation of positioning the printing head 22 to the maintenance tray 17. While the printing operation is performed, the maintenance tray 17 is retracted to a feeding side of the printing apparatus 1 from the printing unit 8.

In a case of performing a maintenance operation of the printing head 22, the printing head 22 is moved to a position above the sheet conveyance unit housing 81 by the above-mentioned ascending/descending mechanism of the printing head, and the maintenance tray 17 is moved to a position retracted from the printing head (illustrated in FIG. 6A and referred to as a retraction position).

Thereafter, as illustrated in FIG. 6B, the maintenance tray 17 is moved to a position below the printing head 22 from the retraction position by a not-illustrated driving mechanism and rail.

The maintenance tray 17 includes the against-printing-head positioning member 171, and a positioning member 221 of the printing head 22 is provided to a lower portion of the printing head 22. As illustrated in FIG. 6C, the printing head 22 is positioned to the maintenance tray 17 by descending of the printing head 22.

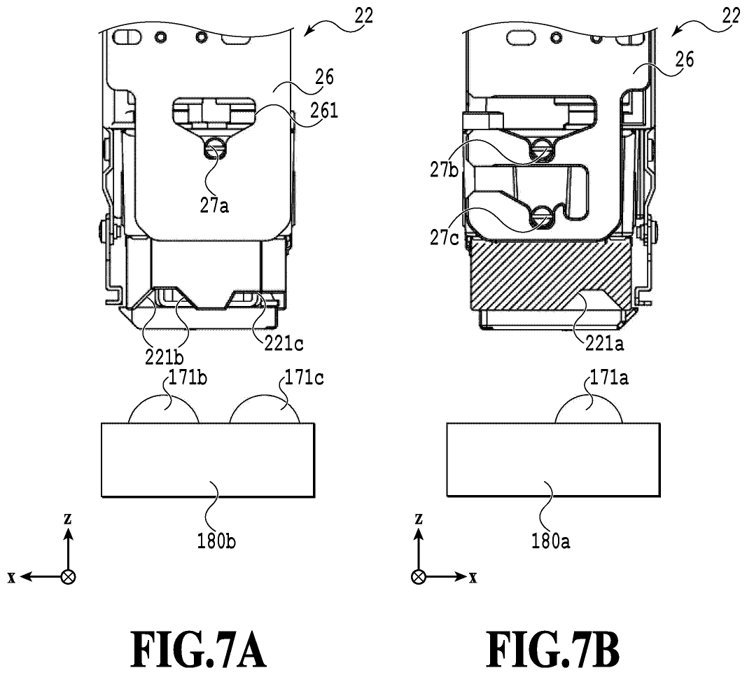

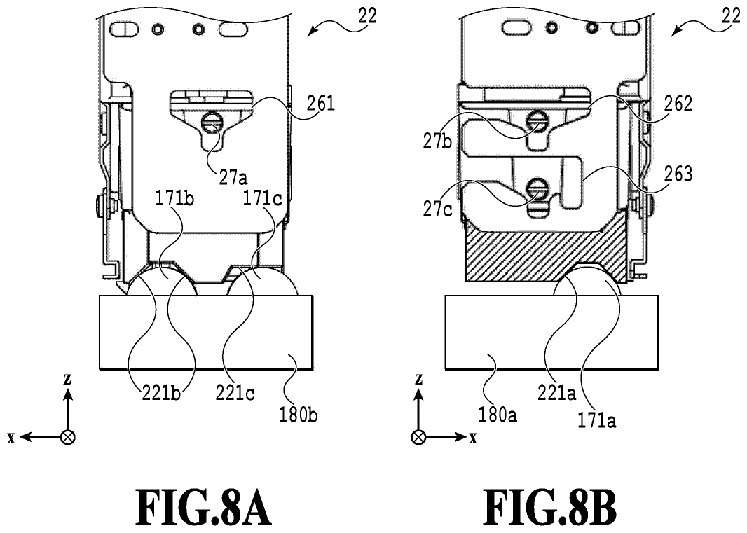

FIGS. 7A and 7B each illustrate a state in which the positioning member 221 of the printing head 22 is distant from the against-printing-head positioning member 171 of the maintenance tray 17. On the other hand, FIGS. 8A and 8B each illustrate a state in which positioning of the positioning member 221 to the against-printing-head positioning member 171 is completed. Note that, FIGS. 7A and 8A are diagrams of a view from an apparatus back surface side, and FIGS. 7B and 8B are diagrams of a view from an apparatus front surface side. Additionally, as illustrated in FIGS. 7A and 7B and FIGS. 8A and 8B, as the positioning member 221, there are a recess portion 221a in a conical shape, a groove portion 221b in a V-shape, and a flat surface portion 221c.

As illustrated in FIGS. 7A and 7B and FIGS. 8A and 8B, the positioning member 221 of the printing head 22 is put in contact with the against-printing-head positioning member 171 of the maintenance tray 17 by descending of the printing head holding unit 26. In addition, a first pin 27a of the printing head 22 is moved away from a first hole 261 of the printing head holding unit 26, a second pin 27b is moved away from the second hole 262, and a third pin 27c is moved away from a third hole 263 by descending of the printing head holding unit 26. In this process, the positioning member 221 of the printing head 22 is balanced by the against-printing-head positioning member 171, and the printing head 22 is accurately positioned to the maintenance tray 17.

### <Configuration of Maintenance Unit>

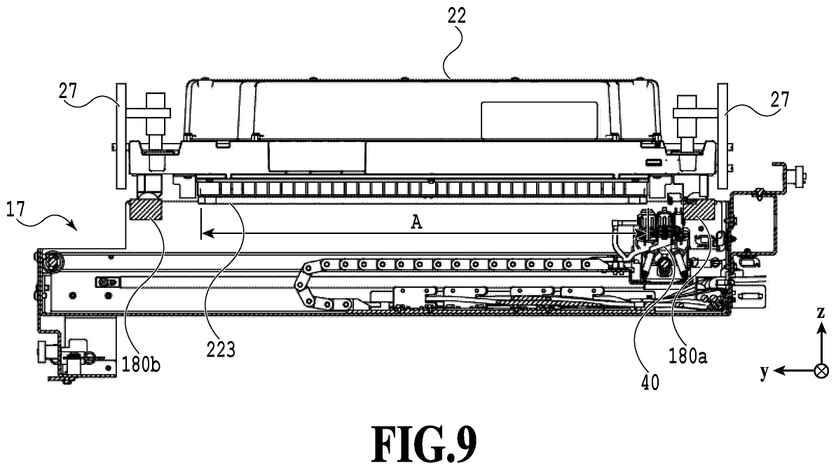

FIG. 9 illustrates a state in which the printing head 22 is positioned in the maintenance tray 17. The nozzle formation surface 223 of the printing head 22 is cleaned by the maintenance unit 40 having various functions for cleaning. Additionally, a region on a lower side (a −z direction side) of the nozzle formation surface 223 is defined as a printing region A (or a projection region A). A configuration example of the maintenance unit 40 is described later. Note that, the maintenance unit is also referred to as a “cleaning unit”.

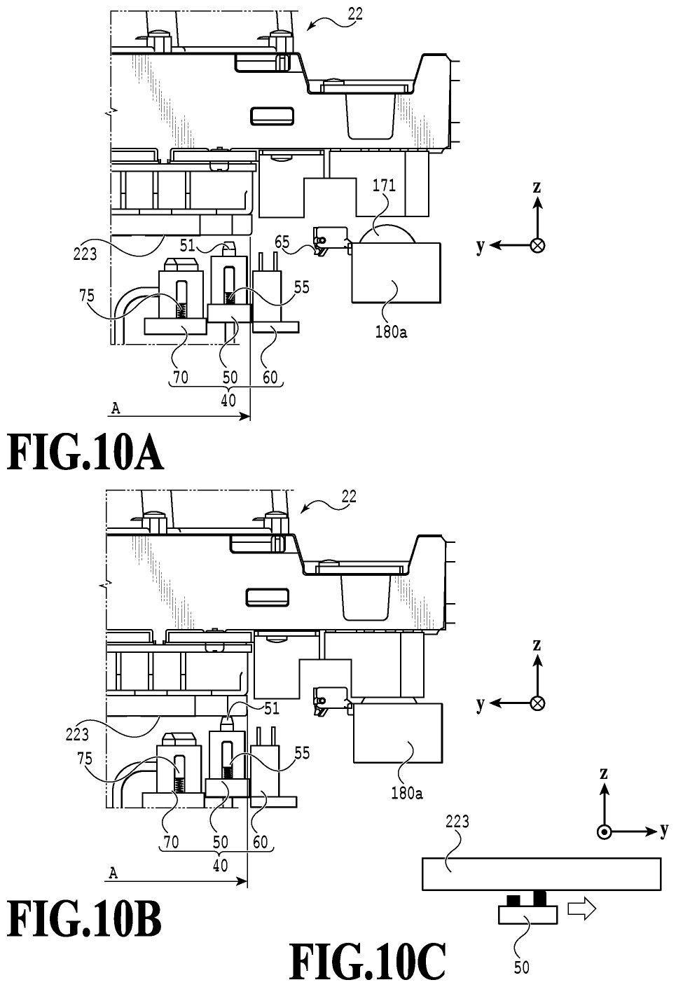

FIGS. 10A and 10B are enlarged views illustrating a positional relationship between the printing head 22 positioned in the maintenance tray 17 and the maintenance unit 40 in a state of being stopped on a front side of the maintenance tray 17. The maintenance unit 40 includes a cleaning liquid application unit 50, a liquid removal unit 60, and a negative pressure application unit 70. The cleaning liquid application unit 50 is a mechanism to apply the cleaning liquid to the nozzle formation surface 223 of the printing head 22, and FIGS. 10A and 10B illustrate a cleaning start position of the cleaning liquid application unit 50 (details are described later). The liquid removal unit 60 is a mechanism to remove the ink, paper dust, the cleaning liquid, and the like adhering to the printing head 22. The negative pressure application unit 70 is a mechanism to apply a negative pressure to the nozzle plate 224 of the printing head 22 to remove the ink stuck in the nozzle unit or bubbles in the ink channel. The cleaning liquid application unit 50, the liquid removal unit 60, and the negative pressure application unit 70 each can scan in the y direction while being put in contact with the nozzle formation surface 223 of the printing head 22.

Here, a series of maintenance operations by the maintenance unit 40 is described. First, the cleaning liquid is applied to the nozzle formation surface 223 by the cleaning liquid application unit 50. Then, the sticking force of the ink stuck on the nozzle formation surface 223 is reduced by the effect of the applied cleaning liquid. Thereafter, with wiping by the liquid removal unit 60, the stuck ink and the cleaning liquid are removed from the nozzle formation surface 223. Thereafter, the negative pressure application unit 70 acts on the nozzle plate 224 and performs negative pressure suction, and the ink stuck in the nozzle unit and fine bubbles in the ink channel are thus removed. Note that, in this case, the above-mentioned three cleaning mechanisms are described as the cleaning mechanism forming the maintenance unit; however, a type of the cleaning mechanism is not limited to these three. A configuration to arrange another cleaning mechanism may be applied, such as a configuration in which the nozzle formation surface 223 is cleaned by putting a web for wiping out in contact therewith and a configuration in which a porous body is put in contact with the nozzle formation surface.

### <Cleaning Start Position of Each Cleaning Mechanism Forming Maintenance Unit>

The cleaning start position corresponding to each cleaning mechanism forming the maintenance unit is described below with reference to FIGS. 10A to 12C.

FIG. 10A illustrates an example of the cleaning start position of the cleaning liquid application unit 50. The cleaning liquid application unit 50 includes a cleaning liquid application member 51 including a portion that has flexibility and is put in contact with the nozzle formation surface 223 and a bias member 55. The cleaning start position of the cleaning liquid application unit 50 is within the printing region A below the nozzle formation surface 223. The printing head 22 is moved in a −z direction and put in contact with the cleaning liquid application unit 50 standing by in the cleaning start position. Then, as illustrated in FIG. 10B, a pressing pressure in the −z direction is applied to the cleaning liquid application member 51 having flexibility at a tip of the cleaning liquid application unit 50, and repulsion in a spring bias direction (a +z direction) acts by the bias member 55. Thus, it is possible to obtain the proper orientation of the cleaning liquid application unit 50 to start cleaning. After cleaning is started, the maintenance unit 40 advances in the +y direction.

As illustrated in FIG. 10C, the cleaning liquid application unit 50 includes rubber on a rear side in a scanning direction that is notched by 1 mm in the Z direction so as to stably apply the liquid to the printing head. FIG. 10C illustrates a configuration in which the maintenance unit 40 including the cleaning liquid application unit 50 scans from the front side to the rear side in the +y direction while applying the cleaning liquid by the cleaning liquid application unit 50; however, it is not limited to this configuration. A configuration in which the maintenance unit 40 scans in the −y direction while applying the cleaning liquid by the cleaning liquid application unit 50 may be applied. Note that, in this configuration, the position of the notch is on a +y direction side of a portion without notch.

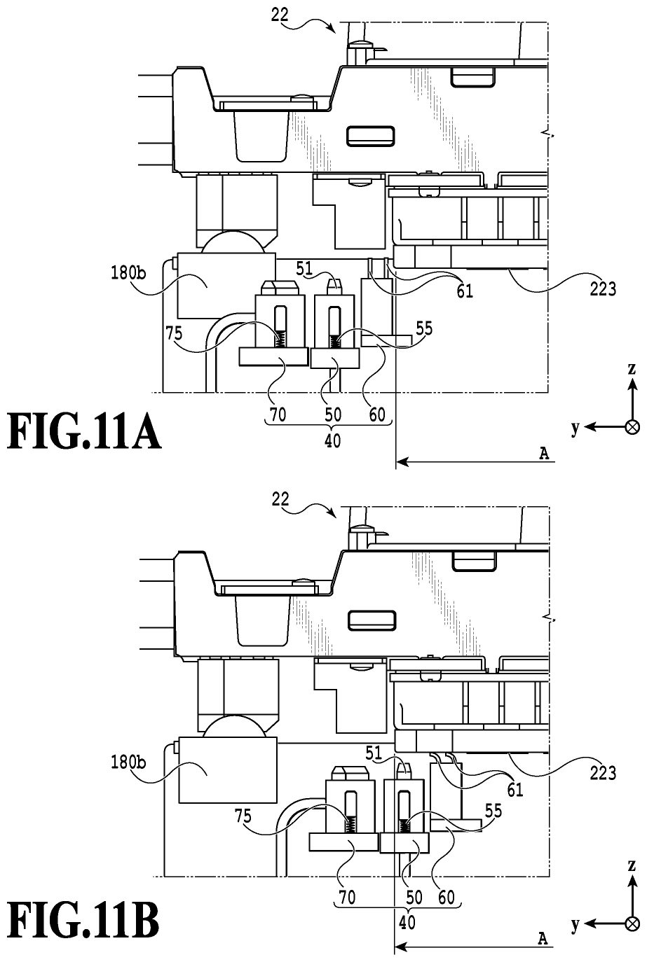

FIG. 11A illustrates an example of a cleaning start position of the liquid removal unit 60. The liquid removal unit 60 includes a blade 61 that has flexibility. The number of the blade 61 may be one or more. As illustrated in FIG. 11A, the cleaning start position of the liquid removal unit 60 is a position outside the printing region A below the nozzle formation surface 223 in which the blade 61 is put in contact with no part. Thus, as illustrated in FIG. 11B, after cleaning is started, in a case where the maintenance unit 40 advances in the −y direction, and the blade 61 enters the inside of the printing region A, a deflection direction of the blade 61 put in contact with the nozzle formation surface 223 is uniform (the opposite direction of the advancing direction of the maintenance unit 40). Accordingly, good removal performance is assured.

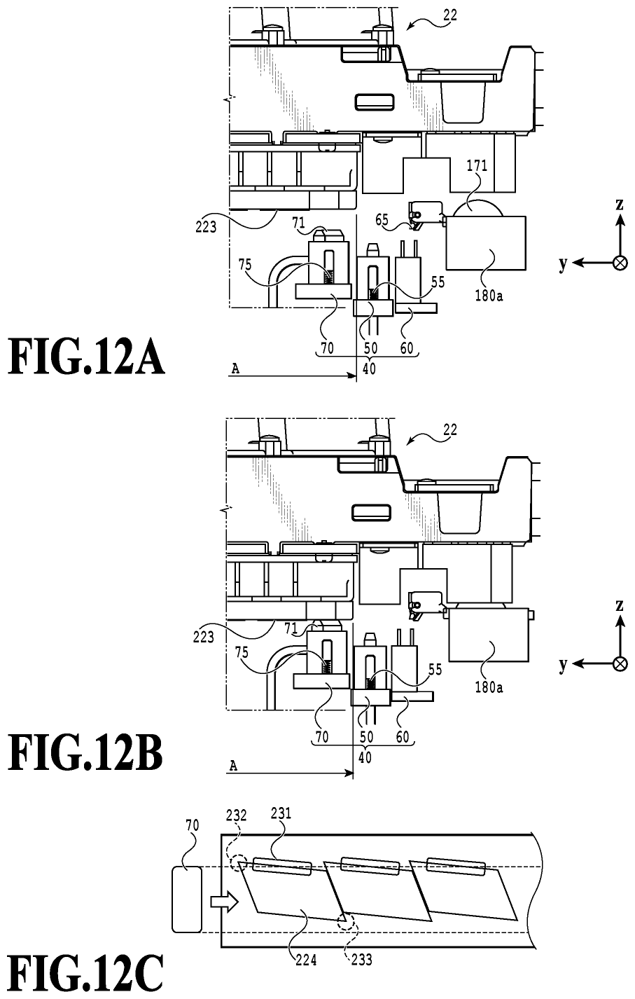

FIG. 12A illustrates an example of a cleaning start position of the negative pressure application unit 70. The negative pressure application unit 70 includes a negative pressure application member 71 including a portion that has flexibility and is put in contact with the nozzle formation surface 223 and a bias member 75. The cleaning start position of the negative pressure application unit 70 is within the printing region A below the nozzle formation surface 223. The printing head 22 is moved in the −z direction and put in contact with the negative pressure application unit 70 standing by in the cleaning start position. Then, as illustrated in FIG. 12B, a pressing pressure in the −z direction is applied to the negative pressure application member 71 having flexibility at a tip of the negative pressure application unit 70, and repulsion in a spring bias direction (the +z direction) acts by the bias member 75. Thus, it is possible to obtain the proper orientation of the negative pressure application unit 70 to start cleaning. After cleaning is started, the maintenance unit 40 advances in the +y direction.

Since the negative pressure application unit 70 scans while sucking with the negative pressure, the scanning is performed while being strongly and closely attached to the nozzle plate. Therefore, if the negative pressure application unit 70 advances in a direction to be mounted on a sharp angle portion 233 of the nozzle plate 224 illustrated in FIG. 12C, this causes easy abrasion of the rubber forming the negative pressure application unit 70. In a case where the rubber of the negative pressure application unit 70 is abraded, the rubber needs to be replaced. The maintenance unit 40 scans from the front side to the rear side in the +y direction such that the negative pressure application unit 70 advances in a direction not to be mounted on the sharp angle portion 233 of the nozzle plate 224.

Note that, it is designed such that the negative pressure application unit 70 is not put in contact with a sharp angle portion 232 of the nozzle plate 224. This is a result of taking into consideration that a sealing material 231 protecting a wire connected with the nozzle plate has a shape bulging from the nozzle plate 224 by about 0.3 mm. That is, in a case where the negative pressure application unit 70 is mounted on the sealing material 231 like straddling, leaking of the negative pressure is increased, and a necessary negative pressure cannot act on the nozzle plate. For this reason, it is designed that the negative pressure application unit 70 is partially mounted on the sealing material 231.

### <Movement Mechanism to Move (Ascend/Descend) Each Cleaning Mechanism Forming Maintenance Unit>

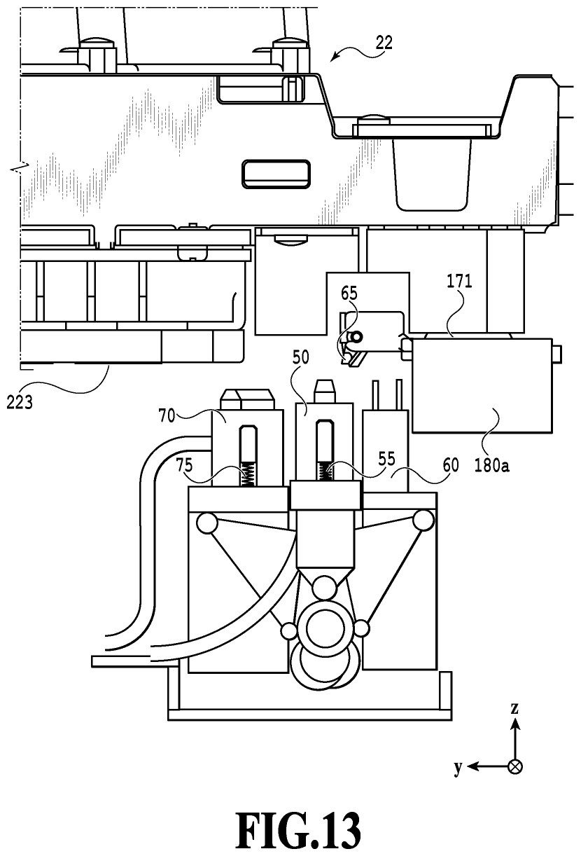

FIG. 13 illustrates a state in which the printing head 22 is positioned to the against-printing-head positioning member 171 held by the beam member 180 and a state in which the cleaning liquid application unit 50, the liquid removal unit 60, and the negative pressure application unit 70 are retracted in the −z direction from a height of the nozzle formation surface 223. In this state, none of the cleaning liquid application unit 50, the liquid removal unit 60, and the negative pressure application unit 70 can act on the nozzle formation surface 223. In a case of allowing any one of the cleaning liquid application unit 50, the liquid removal unit 60, and the negative pressure application unit 70 to act on the nozzle formation surface 223, it is necessary to move (ascend) the cleaning mechanism (a functional unit) desired to act to a position (a head contact position) in which the cleaning mechanism can be put in contact with the nozzle formation surface 223.

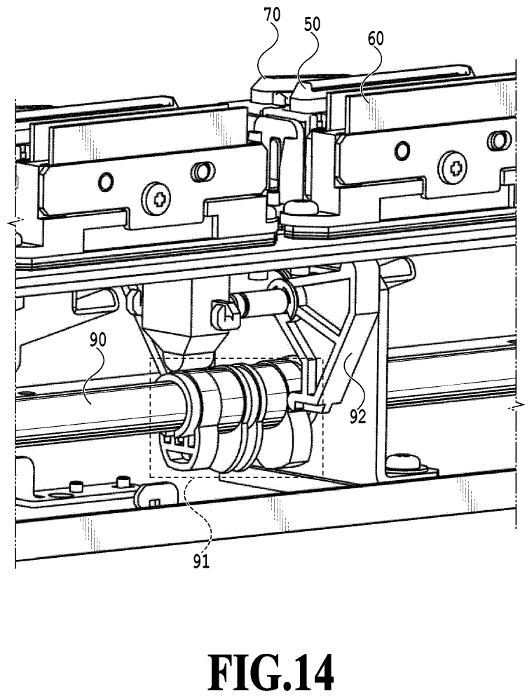

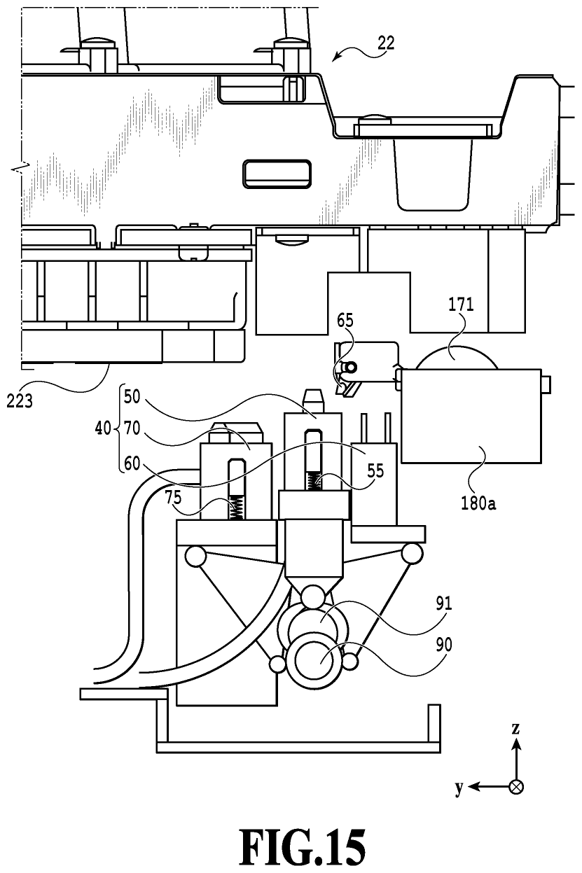

FIG. 14 illustrates a cam mechanism using a cam as an example of the ascending/descending configuration to ascend/descend the above-described three cleaning mechanisms. FIGS. 15 to 17 each illustrate a state in which any one of these three cleaning mechanisms is moved to a height (this height is defined as a “head contact height”) at which the cleaning mechanism is put in contact with the nozzle formation surface 223 of the printing head 22. Note that, the maintenance unit 40 illustrated in FIGS. 15 to 17 is positioned in a standby position in the y direction, and the negative pressure application unit 70 in the standby position is in a position in which the negative pressure application unit 70 is overlapped with the nozzle formation surface 223 in the y direction. As illustrated in FIG. 15 and so on, in the ascending/descending operation of each cleaning mechanism, it is a state in which the printing head 22 is retracted to a position away from the against-printing-head positioning member 171 by a predetermined distance in the +z direction. Thus, the negative pressure application unit 70 is not put in contact with the nozzle formation surface 223 of the printing head 22 during the ascending/descending operation of each cleaning mechanism of the maintenance unit 40, and it is possible to smoothly ascend/descend each cleaning mechanism.

FIG. 15 illustrates a state in which the cleaning liquid application unit 50 is moved to the head contact height in a case where a y direction position of the maintenance unit 40 is a position (the standby position) (this y direction position is defined as a “first position”) in which the height of each cleaning mechanism in the maintenance unit 40 can be changed. The cleaning liquid application unit 50 can perform the ascending/descending operation by following a first cam 91 accompanying to a shaft 90 provided below the maintenance unit 40.

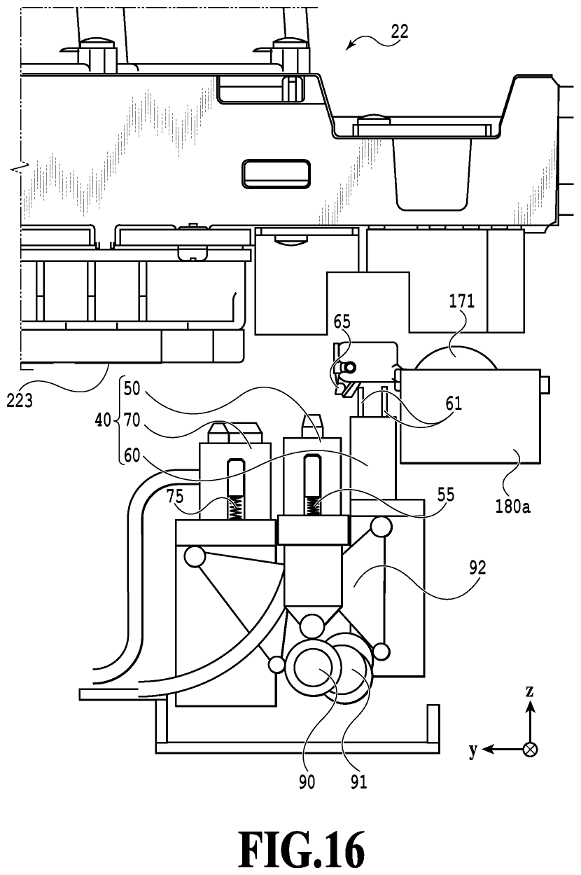

FIG. 16 illustrates a state in which the liquid removal unit 60 is moved to the head contact height in a case where the maintenance unit 40 is in the first position. The liquid removal unit 60 can perform the ascending/descending operation by operations of the first cam 91 accompanying to the shaft 90 provided below the maintenance unit 40 and a second cam 92 arranged below the liquid removal unit 60 and following the first cam 91 in conjunction with each other.

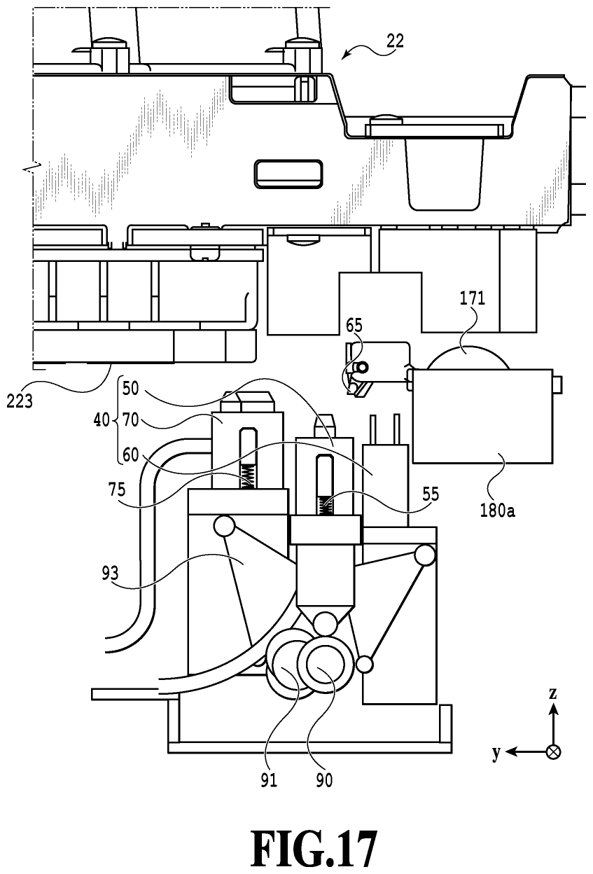

FIG. 17 illustrates a state in which the negative pressure application unit 70 is moved to the head contact height in a case where the maintenance unit 40 is in the first position. The negative pressure application unit 70 can perform the ascending/descending operation by operations of the first cam 91 accompanying to the shaft 90 provided below the maintenance unit 40 and a third cam 93 arranged below the negative pressure application unit 70 and following the first cam 91 in conjunction with each other.

In the present embodiment, as mentioned above, a configuration to ascend/descend each cleaning mechanism of the maintenance unit 40 by using the first cam 91 accompanying to the one shaft 90 is employed. With such a configuration, it is possible to implement ascending/descending of multiple cleaning mechanisms by one driving source, and accordingly, it is possible to ascend/descend the multiple cleaning mechanisms in a small space.

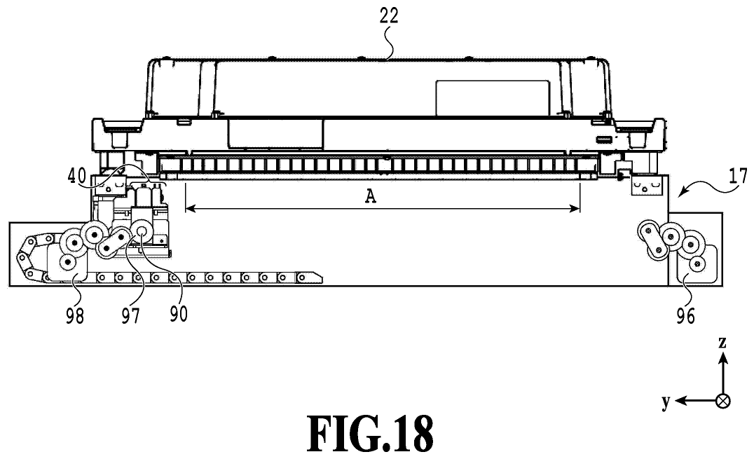

Note that, a case where the position in which the height of each cleaning mechanism in the maintenance unit 40 can be changed is the first position on the apparatus front side is described so far with reference to FIGS. 15 to 17. However, it is possible to apply a configuration in which the height of each cleaning mechanism can be changed also in a second position on the apparatus rear side in addition to the first position. This is described with reference to FIG. 18. Note that, the “second position” is a y direction position in which the height of each cleaning mechanism in the maintenance unit 40 can be changed and is a position different from the first position. Each of the first position and the second position is outside the printing region A of the printing head 22 in the depth direction.

FIG. 18 illustrates a state in which the maintenance unit 40 in the maintenance tray 17 is stopped in the second position on the apparatus rear side. The second position is in the maintenance tray 17 and on the rear side of the printing region A of the printing head 22. As illustrated in FIG. 18, as a configuration to ascend/descend each cleaning mechanism in the maintenance unit 40, a gear train that transmits driving force to a second driving motor 98 and the maintenance unit 40 is also provided on the rear side of the apparatus.

An advantage in a case where the height of each cleaning mechanism in the maintenance unit 40 can be changed in two places on the front side and the rear side of the printing region A as described above is as follows. That is, with such a configuration, it is possible to clean the nozzle formation surface 223 by using different cleaning mechanisms between a case where the maintenance unit 40 is moved from the apparatus front side to the rear side (in the +y direction) and a case where the maintenance unit 40 is moved from the apparatus rear side to the front side (in the −y direction). Accordingly, it is possible to reduce the cleaning time in a case where the nozzle formation surface 223 is cleaned by using the multiple cleaning mechanisms.

### <Arrangement of Blade Cleaner>

Although the nozzle formation surface 223 is cleaned by the maintenance unit 40, in some cases, a blade cleaner 65 (see FIG. 16) is required as a configuration to remove the liquid, paper dust, and the like adhering to the blade 61 to recover the removal performance of the blade 61. It is possible to remove the liquid, paper dust, and the like adhering to the blade 61 from the blade 61 with the blade 61 included in the liquid removal unit 60 passing through the blade cleaner 65 in the +y direction or the −y direction. In a case where the blade cleaner 65 is provided as a part of the cleaning mechanism, and the user additionally needs to perform cleaning of the blade cleaner 65, it is desirable that the blade cleaner 65 is arranged in a position in the maintenance tray 17 that is easily accessed. Accordingly, in the present example, the blade cleaner 65 is arranged on the apparatus front side.

### <Arrangement (Arrangement Order) of Cleaning Mechanisms Forming Maintenance Unit>

It is desirable that the arrangement order of the cleaning mechanisms in the maintenance unit 40 is determined taking into consideration not only the above-mentioned cleaning start position of each of the cleaning liquid application unit 50, the liquid removal unit 60, and the negative pressure application unit 70 but also the accessibility to the blade cleaner 65.

Additionally, there is a possibility of occurrence of a splash of the ink from the blade 61 after the blade 61 passes through the blade cleaner 65. Therefore, it should be taken into consideration that there is a concern that, in a case where a cleaning mechanism other than the liquid removal unit 60, such as the cleaning liquid application unit 50 or the negative pressure application unit 70, is arranged in the ink splash direction, the liquid droplets may splash the other cleaning mechanism.

First, arrangement of the liquid removal unit 60 is described. In the present embodiment, arrangement of the liquid removal unit 60 is determined based on a positional relationship with the blade cleaner 65 taking into consideration the splash of the liquid droplets in a case where the liquid removal unit 60 is put in contact with the blade cleaner 65. In this case, in the printing apparatus having good accessibility from the apparatus front side, it is desirable that the blade cleaner 65 is arranged on the apparatus front side, and it should be noted that the good accessibility of the user to the blade cleaner 65 can be secured with this arrangement.

In a case where the blade cleaner 65 is arranged on the front side, it is desirable to apply a configuration in which the liquid removal unit 60 is arranged in the maintenance tray 17 and on the foremost side out of the three cleaning mechanisms, and the blade 61 and the blade cleaner 65 are put in contact with each other in scanning from the rear side toward the front side (in the −y direction). A splash direction of the liquid droplets that occurs in a case where the liquid removal unit 60 scanning in the −y direction passes through the blade cleaner 65 is the −y direction. Therefore, with the liquid removal unit 60 arranged on the foremost side, it is possible to suppress the splash of the liquid droplets onto the other cleaning mechanism such as the cleaning liquid application unit 50 and the negative pressure application unit 70 arranged on the rear side (+y direction) of the liquid removal unit 60. Thus, regarding arrangement of the liquid removal unit 60 out of the cleaning liquid application unit 50, the liquid removal unit 60, and the negative pressure application unit 70, it is desirable that the liquid removal unit 60 is arranged on the outermost side so as to prevent the cleaning liquid application unit 50 and the negative pressure application unit 70 from passing through the y direction position of the blade cleaner 65.

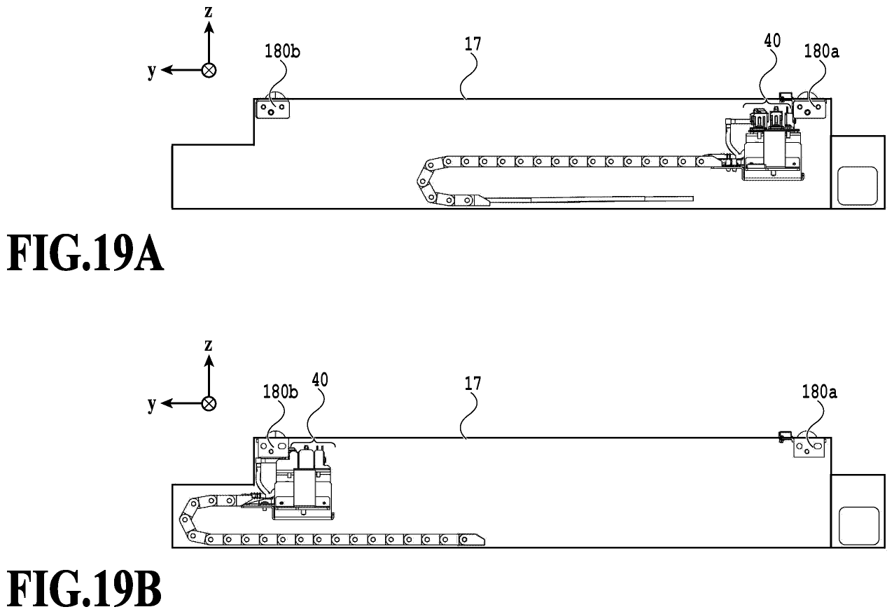

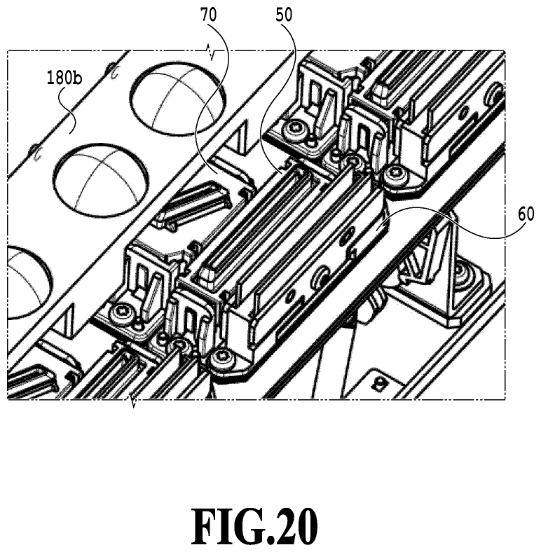

Next, the arrangement order of the cleaning liquid application unit 50 and the negative pressure application unit 70 is described with reference to FIGS. 19A and 19B and FIG. 20. FIG. 19A illustrates a state in which the maintenance unit 40 is in the first position that is the foremost position in the maintenance tray 17. Additionally, FIG. 19B illustrates a state in which the maintenance unit 40 is in the second position that is the rearmost position in the maintenance tray 17. In addition, FIG. 20 is an enlarged view of a state in which the maintenance unit 40 is in the second position that is viewed obliquely.

As illustrated in FIG. 20, the cleaning liquid application unit 50 needs to have an X direction width similar to that of the nozzle formation surface 223 to apply the cleaning liquid to the entire nozzle formation surface 223. In contrast, since the negative pressure application unit 70 is the cleaning mechanism for the nozzle plate 224, an X direction width does not have to be as long as that of the cleaning liquid application unit 50. As illustrated in FIG. 19B, in a case where a movement amount of the maintenance unit 40 needs to be a movement amount that allows for entering below the rear side beam 180b, the negative pressure application unit 70 is arranged on the rearmost side out of the three cleaning mechanisms. With such arrangement, as illustrated in FIGS. 19B and 20, it is possible to reduce a notch amount of the rear side beam 180b to avoid interference more than that in a case where the cleaning liquid application unit 50 is arranged on the rearmost side. Accordingly, it is possible to form the maintenance tray 17 having high strength.

Note that, although a mode in which the liquid removal unit 60, the cleaning liquid application unit 50, and the negative pressure application unit 70 are arranged in this order from the apparatus front side as an arrangement example of the cleaning mechanisms forming the maintenance unit 40 is described herein, the arrangement order of the cleaning mechanisms is not limited to this order.

### <Configuration Related to Driving Force Transmission for Ascending/Descending of Each Cleaning Mechanism in Maintenance Unit>

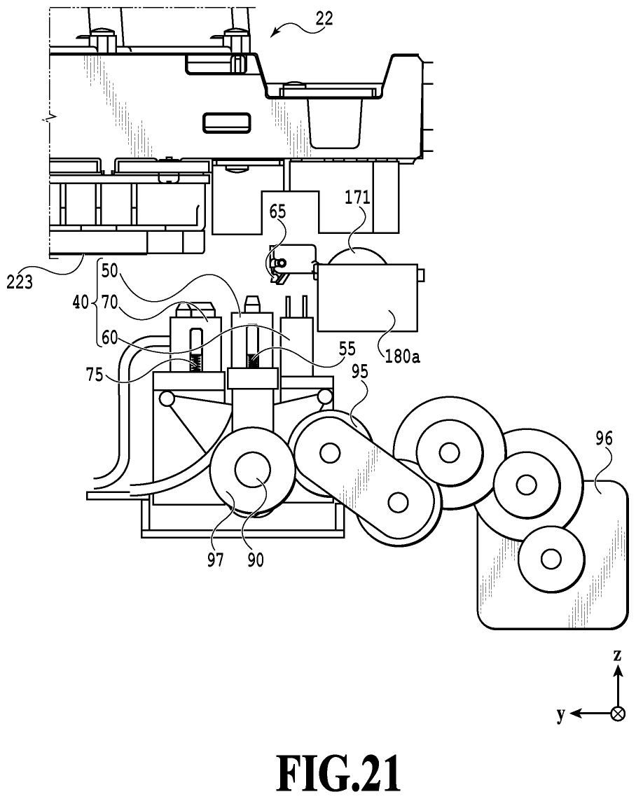

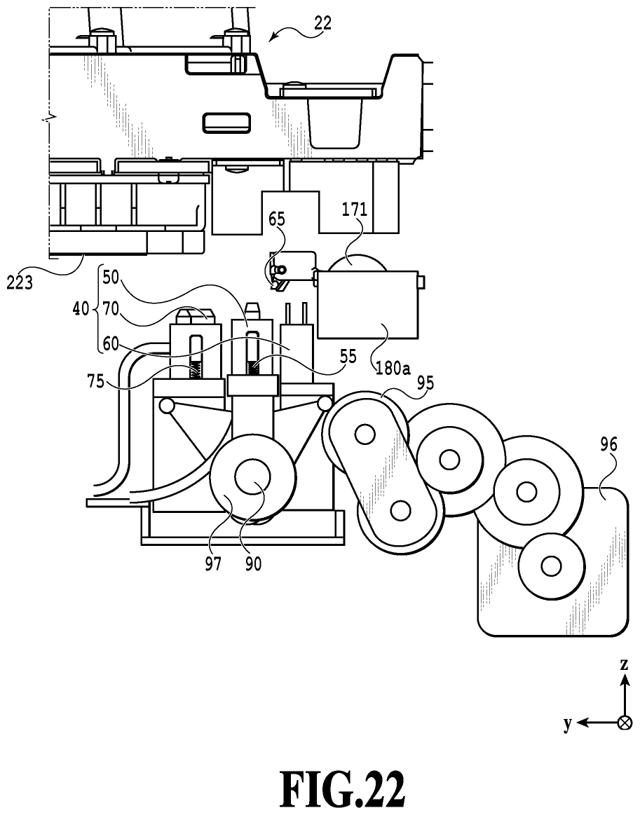

It is necessary to supply the driving force from the driving source coupled to the maintenance unit 40 for the ascending/descending operation of each cleaning mechanism in the maintenance unit 40. In the present embodiment, a configuration using a driving motor 96 as the driving source and the gear train is used as a driving force transmission unit is employed. Such a configuration is described with reference to FIGS. 21 and 22.

FIG. 21 illustrates a driving force transmission route from the driving motor 96 to the shaft 90 that allows each cleaning mechanism in the maintenance unit 40 to ascend/descend. As illustrated in FIG. 21, the gear train has a configuration including a pendulum gear 95 as a part thereof, and it is possible to rotate the shaft 90 by rotating the driving motor 96 and to move an arbitrary cleaning mechanism in the maintenance unit 40 to the contact position. Additionally, as illustrated in FIG. 22, in a case where a rotation direction of the driving motor 96 is inverted while the maintenance unit 40 is in the first position, the pendulum gear 95 is moved away from a shaft gear 97. Likewise, in a case where a rotation direction of the second driving motor 98 is inverted while the maintenance unit 40 is in the second position, the pendulum gear is moved away from the shaft gear 97 (see FIG. 18). Note that, even in a case where the shaft gear 97 is separated from the driving source for ascending/descending of the maintenance unit 40, a state in which a specific cleaning mechanism ascends in the maintenance unit 40 is maintained.

In a case where the driving motor 96 is controlled by the control unit 21, and a desired cleaning mechanism is moved to the contact position of the nozzle formation surface 223 to perform the cleaning operation, the maintenance unit 40 needs to scan in the +y direction or the −y direction. A configuration in which the driving motor 96 for ascending/descending of the cleaning mechanism is moved while being coupled to the maintenance unit 40 during the y direction scanning of the maintenance unit 40 may also be considered. However, with such a configuration, the drivingly coupling unit is also moved in the +y direction or the −y direction in addition to the driving motor 96. Therefore, the size of a unit group moved along the y direction (in this case, including the maintenance unit 40, the driving motor 96, and the drivingly coupling unit) during scanning of the maintenance unit 40 is increased.

On the other hand, it is possible to reduce the size of a unit group moved along the y direction by separating the driving motor 96 and the gear train for driving force transmission from the maintenance unit 40 as mentioned above (in this case, not including the driving motor 96 and the drivingly coupling unit). Accordingly, this contributes to downsizing of the printing apparatus.

Note that, although the pendulum gear 95 is employed as a coupling/releasing unit that switches between a state of transmitting the driving force to the maintenance unit 40 (a coupling state) and a state of not transmitting the driving force (a coupling release state) in the present embodiment, the coupling/releasing unit is not limited to the pendulum gear 95.

### Second Embodiment

In the first embodiment, only arbitrary one cleaning mechanism in the maintenance unit 40 is moved to the head contact height, and only the moved one cleaning mechanism is allowed to act on the nozzle formation surface 223. In contrast, in the present embodiment, arbitrary multiple cleaning mechanisms in the maintenance unit 40 are moved to the head contact height, and the moved multiple cleaning mechanisms are allowed to act on the nozzle formation surface 223 concurrently.

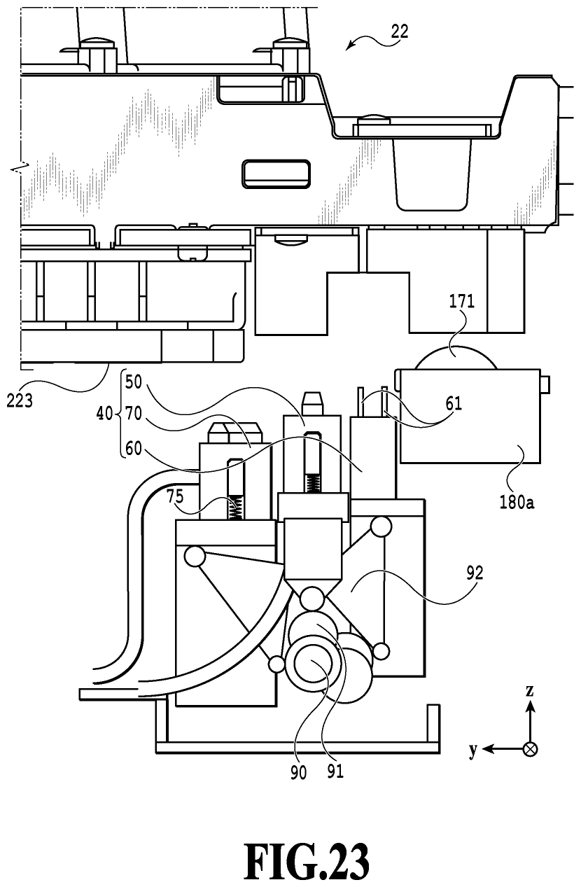

FIG. 23 is a schematic view illustrating a state in which the liquid removal unit 60 and the cleaning liquid application unit 50 are at the head contact height. In this state, the printing head 22 descends and is positioned to the against-printing-head positioning member 171.

As illustrated in FIG. 23, in the present embodiment, a cam having a different shape from that in the first embodiment is employed for the first cam 91 arranged below the maintenance unit 40. Specifically, a cam shape that can move both the liquid removal unit 60 and cleaning liquid application unit 50 to the head contact height is employed. With such a cam employed, it is possible to move the liquid removal unit 60 and the cleaning liquid application unit 50 to the head contact height concurrently.

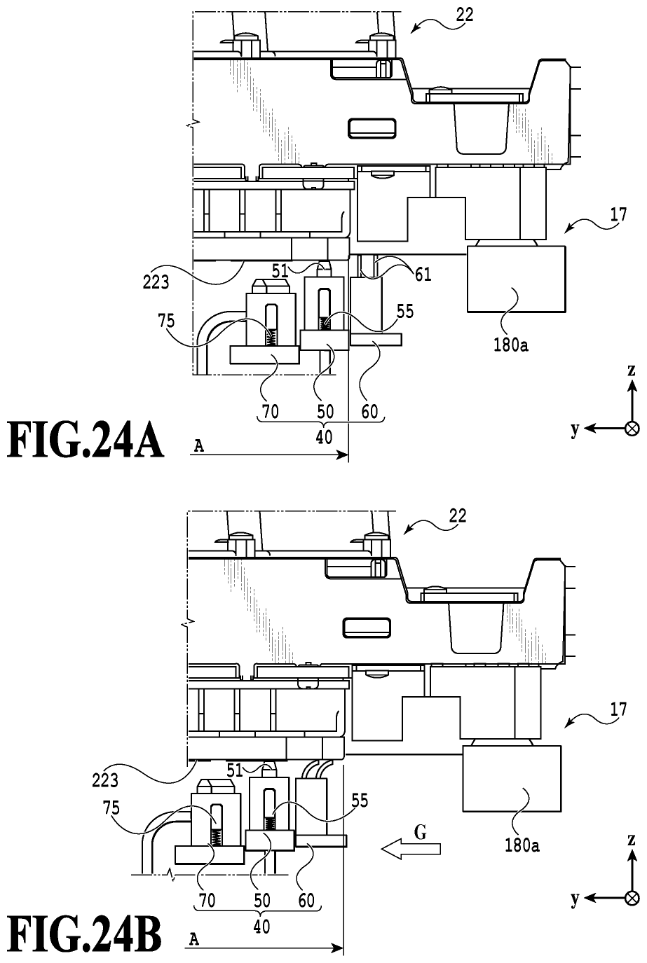

FIG. 24A is a schematic view illustrating a state in which the printing head 22 is moved in the −z direction and positioned to the maintenance tray 17 with respect to the liquid removal unit 60 and the cleaning liquid application unit 50 standing by in the cleaning start position. Additionally, FIG. 24B illustrates a state immediately after the maintenance unit 40 starts moving in a direction of an arrow G.

The cleaning start position of the cleaning liquid application unit 50 is in the printing region A below the nozzle formation surface 223. The printing head 22 is moved in the −z direction and put in contact with the cleaning liquid application unit 50 standing by in the cleaning start position. Then, as illustrated in FIG. 24A, the pressing pressure in the −z direction is applied to the cleaning liquid application member 51 at the tip of the cleaning liquid application unit 50 that has flexibility, and repulsion in the spring bias direction (+z direction) acts by the bias member 55. Thus, it is possible to obtain the proper orientation of the cleaning liquid application unit 50 to start cleaning.

The cleaning start position of the liquid removal unit 60 is a position outside the printing region A below the nozzle formation surface 223 and in which the blade 61 is put in contact with no part. With such a configuration, after cleaning is started, and once the blade 61 enters the inside of the printing region A, a deflection direction of the blade 61 put in contact with the nozzle formation surface 223 is the opposite direction of the advancing direction of the maintenance unit 40, and good removal performance is assured.

After the cleaning liquid is applied to the nozzle formation surface 223, if the process proceeds to the printing operation without removing the cleaning liquid from the nozzle formation surface 223, there is a possibility that a liquid droplet of the cleaning liquid adhering on the nozzle formation surface 223 adheres to the printing medium. Accordingly, it is necessary to remove the liquid droplet adhering on the nozzle formation surface 223 before the next printing operation, and to this end, the liquid removal operation by the liquid removal unit 60 is required. In the present embodiment, in the G direction in which the maintenance unit 40 scans, the cleaning liquid application unit 50 is arranged downstream while the liquid removal unit 60 is arranged upstream, and the cleaning liquid application unit 50 and the liquid removal unit 60 are allowed to act on the nozzle formation surface 223 concurrently. Thus, it is possible to reduce the time required to clean the printing head 22 more than a case where the cleaning liquid application unit 50 and the liquid removal unit 60 act individually and sequentially.

In addition to the above-described configuration in which the cleaning liquid application unit 50 and the liquid removal unit 60 are allowed to act on the printing head 22 concurrently, a configuration in which the cleaning liquid application unit 50 and the negative pressure application unit 70 are allowed to act concurrently may also be considered. This configuration is also effective to reduce the cleaning time of the printing head 22. In a case where the negative pressure application unit 70 is allowed to act on the nozzle formation surface 223, since the negative pressure application member 71 having flexibility slides with respect to the nozzle formation surface 223, it is desirable that the cleaning liquid application unit 50 is arranged downstream of the negative pressure application unit 70 in the direction in which the maintenance unit 40 scans. With such arrangement, it is possible to reduce a sliding resistance by arranging the cleaning liquid between the nozzle formation surface 223 and the negative pressure application member 71 and to stabilize the negative pressure application operation. After the cleaning liquid application unit 50 and the negative pressure application unit 70 act concurrently, the liquid removal unit 60 is allowed to act on the nozzle formation surface 223. Thus, the remaining liquid droplet of the cleaning liquid on the nozzle formation surface 223 is removed.

Additionally, a configuration in which the liquid removal unit 60 and the negative pressure application unit 70 are allowed to act concurrently may also be considered. This configuration is also effective to reduce the cleaning time of the printing head 22. In this configuration, it is possible to recover the ejection performance of the printing head 22 by allowing the liquid removal unit 60 and the negative pressure application unit 70 to act on the nozzle formation surface 223 concurrently after the cleaning liquid application unit 50 is allowed to act on the nozzle formation surface 223. Moreover, in the direction in which the maintenance unit 40 is moved during the cleaning operation, the liquid removal unit 60 is arranged downstream while the negative pressure application unit 70 is arranged upstream. Thus, it is possible to remove the liquid droplet of the cleaning liquid adhering on the nozzle formation surface 223 by the liquid removal unit 60 and to suppress adhering of the liquid droplet to the negative pressure application unit 70.

With the above-described configuration, it is possible to maintain the cleaning capability of the printing head 22 for long time.

### Other Embodiments

The order to operate the three cleaning mechanisms is described below.

There is a case where paper dust is generated from the printing medium during the printing operation, and the paper dust adheres to the printing head. To deal with this, the printing head is cleaned once the printing time, the passing paper number, or the ink ejection number during printing (the dot number) exceeds a predetermined threshold.

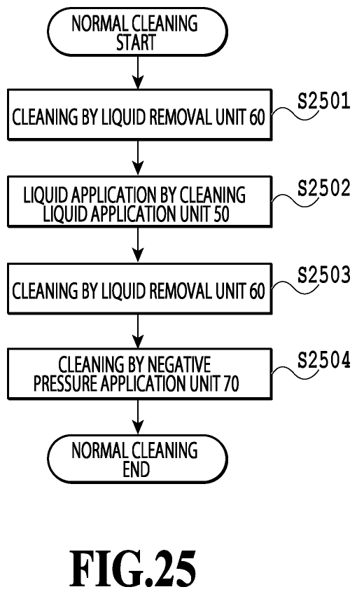

FIG. 25 is a flowchart of cleaning (normal cleaning) that is executed on a regular basis during the printing operation as described above. If the liquid application operation is performed first by the cleaning liquid application unit 50, the paper dust adheres to the cleaning liquid application unit 50. Thus, the paper dust is accumulated on the cleaning liquid application unit 50 and eventually leads reduction of the cleaning liquid application performance.

Therefore, first, in a step S2501, the paper dust is removed by performing the cleaning operation by the liquid removal unit 60. Subsequently, in a step S2502, the liquid application operation by the cleaning liquid application unit 50 is performed. Subsequently, in a step S2503, the cleaning operation by the liquid removal unit 60 is performed, and thus the stuck ink and the cleaning liquid are removed from the nozzle formation surface 223. Subsequently, in a step S2504, cleaning by the negative pressure application unit 70 is performed to remove the stuck ink near the nozzle.

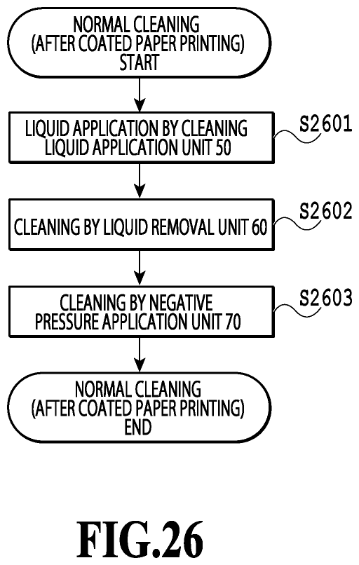

Note that, although FIG. 25 shows the normal cleaning assuming the printing medium that is likely to generate paper dust, normal cleaning of a different flow may be executed after printing on the printing medium that is less likely to generate paper dust. In general, since coated paper includes a coated surface layer, loading material and the like of the sheet rarely falls off during conveyance, and the amount of the paper dust generated during printing is considerably small. On the other hand, since non-coated paper is not coated, the amount of the paper dust generated during printing is great. For this reason, the amount of the paper dust adhering to the printing head after the printing on the coated paper is less than that after the printing on the non-coated paper. Therefore, in a case where the coated paper is selected in setting of the printing medium for printing, or after the printing on the coated paper is performed, normal cleaning (after coated paper printing) illustrated in FIG. 26 is performed.

As mentioned above, since the amount of the paper dust adhering to the printing head after the coated paper printing is small, the paper dust is unlikely to adhere to the liquid application unit 60 even in a case where the liquid application operation by the cleaning liquid application unit 50 is performed first. Therefore, in a step S2601, the cleaning operation by the liquid removal unit 60 is not performed, and the liquid application operation by the cleaning liquid application unit 50 is performed from the beginning. Subsequently, in a step S2602, the cleaning operation by the liquid removal unit 60 is performed. Subsequently, in a step S2603, cleaning by the negative pressure application unit 70 is performed. Note that, the cleaning shown in FIG. 26 is performed in a timing in which the printing time, the passing paper number, or the ink ejection number during printing (the dot number) exceeds the predetermined threshold as with FIG. 25; however, it is performed only in a case where the printing media printed after the last cleaning are only the coated paper. In a case where the coated paper and the non-coated paper are mixed in the printing media printed after the last cleaning, the normal cleaning shown in FIG. 25 may be executed.

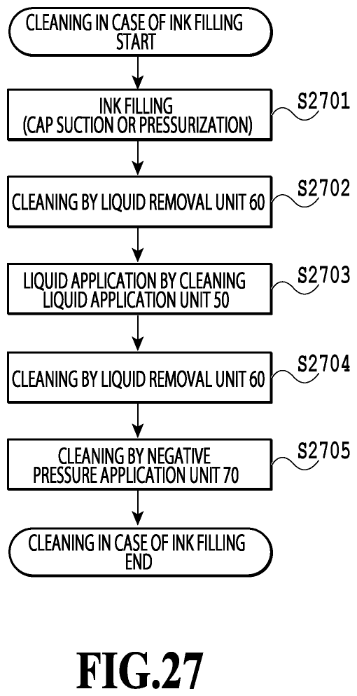

FIG. 27 is a flowchart of cleaning (in a case of ink filling) executed in a case where the printing head is filled with the ink after the printing apparatus is disposed, unlike the normal cleaning executed on a regular basis.

In a step S2701, the printing head is filled with the ink by a pressurization operation from a supply pump connected to the printing head and a suction operation by a negative pressure pump via a cap sealing the printing head. In this case, a large amount of the ink is discharged from the nozzle, and the amount of the ink adhered onto the nozzle formation surface 223 is increased. Therefore, in a step S2702, the liquid removal operation by the liquid removal unit 60 is performed. Subsequently, in a step S2703, the liquid application operation by the cleaning liquid application unit 50 is performed. Subsequently, in a step S2704, the cleaning operation by the liquid removal unit 60 is performed. Subsequently, in a step S2705, cleaning by the negative pressure application unit 70 is performed.

Note that, although a mode in which the liquid application operation, the liquid removal operation, and the negative pressure application operation are each executed only once is described in FIGS. 25 to 27, the number of the corresponding operations may be multiple times. For example, in the flow shown in FIG. 27, a mode in which the liquid removal operation (S2702) is performed multiple times in a case where the ink adhering amount to the nozzle formation surface after the cap suction is great may be applied.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to downsize a printing apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-121676, filed Jul. 26, 2023 and No. 2023-178649, filed Oct. 17, 2023, which are hereby incorporated by reference wherein in their entirety.

What is claimed is:

1. A printing apparatus, comprising:
a cleaning unit including a plurality of cleaning mechanisms configured to clean a printing head ejecting a liquid, each of the plurality of cleaning mechanisms scanning in a predetermined direction while contacting the printing head;
a movement mechanism configured to move each of the plurality of cleaning mechanisms between a first height in contact with the printing head and a second height not in contact with the printing head;
a driving source of the movement mechanism; and
a coupling/releasing unit configured to perform coupling/releasing between the driving source and the movement mechanism, wherein
one or more cleaning mechanisms of the plurality of cleaning mechanisms are moved to the first height by the movement mechanism coupled with the driving source, and
after the one or more cleaning mechanisms are moved to the first height, the coupling/releasing unit releases coupling between the driving source and the movement mechanism.

2. The printing apparatus according to claim 1, wherein
the predetermined direction is a depth direction orthogonal to a height direction and a conveyance direction of a printing medium.

3. The printing apparatus according to claim 2, wherein
the plurality of cleaning mechanisms include a first cleaning mechanism that applies a cleaning liquid, a second cleaning mechanism that removes the cleaning liquid, and a third cleaning mechanism that applies a negative pressure.

4. The printing apparatus according to claim 3, wherein
in the depth direction, assuming that a direction from a front side toward a rear side is a first depth direction, the second cleaning mechanism, the first cleaning mechanism, and the third cleaning mechanism are arranged in this order from an upstream side of the first depth direction.

5. The printing apparatus according to claim 4, further comprising:
a cleaner that cleans the second cleaning mechanism, wherein
the cleaner is provided on the front side in the depth direction.

6. The printing apparatus according to claim 5, wherein
in a case where the first cleaning mechanism scans in the depth direction, the first cleaning mechanism does not pass through a position of the cleaner,
in a case where the second cleaning mechanism scans in the depth direction, the second cleaning mechanism passes through the position of the cleaner, and
in a case where the third cleaning mechanism scans in the depth direction, the third cleaning mechanism does not pass through the position of the cleaner.

7. The printing apparatus according to claim 4, wherein
a width of the third cleaning mechanism in the conveyance direction is shorter than a width of the first cleaning mechanism in the conveyance direction.

8. The printing apparatus according to claim 3, wherein
in a first position on a front side in the depth direction, the movement mechanism ascends/descends each of the plurality of cleaning mechanisms.

9. The printing apparatus according to claim 8, wherein
in the first position, the coupling/releasing unit releases coupling between the driving source and the movement mechanism.

10. The printing apparatus according to claim 9, wherein
in a second position on a rear side in the depth direction, the movement mechanism ascends/descends each of the plurality of cleaning mechanisms.

11. The printing apparatus according to claim 10, wherein
in the second position, the coupling/releasing unit releases coupling between the driving source and the movement mechanism.

12. The printing apparatus according to claim 11, wherein
each of the first position and the second position are outside a printing region of the printing head in the depth direction.

13. The printing apparatus according to claim 1, wherein
each of the plurality of cleaning mechanisms is coupled with the same driving source.

14. The printing apparatus according to claim 1, further comprising:
a control unit that controls the driving source.

15. The printing apparatus according to claim 3, wherein
after the first cleaning mechanism moved to the first height scans in the predetermined direction while being put in contact with the printing head, the second cleaning mechanism scans in the predetermined direction while being put in contact with the printing head.

16. The printing apparatus according to claim 3, wherein
after the first cleaning mechanism moved to the first height scans in the predetermined direction while being put in contact with the printing head, the third cleaning mechanism scans in the predetermined direction while being put in contact with the printing head.

17. The printing apparatus according to claim 3, wherein
after the second cleaning mechanism moved to the first height scans in the predetermined direction while being put in contact with the printing head, the first cleaning mechanism scans in the predetermined direction while being put in contact with the printing head.

18. The printing apparatus according to claim 3, wherein
the number of times of scanning in the predetermined direction by the first cleaning mechanism, the second cleaning mechanism, and the third cleaning mechanism moved to the first height while being in contact with the printing head includes a plurality of number of times.

19. A control method of a printing apparatus that includes
a cleaning unit including a plurality of cleaning mechanisms configured to clean a printing head ejecting a liquid, each of the plurality of cleaning mechanisms scanning in a predetermined direction while contacting the printing head,
a movement mechanism configured to move each of the plurality of cleaning mechanisms between a first height in contact with the printing head and a second height not in contact with the printing head,
a driving source of the movement mechanism, and
a coupling/releasing unit configured to perform coupling/releasing between the driving source and the movement mechanism, the control method comprising the steps of:
moving one or more cleaning mechanisms of the plurality of cleaning mechanisms to the first height by the movement mechanism coupled with the driving source; and
releasing coupling between the driving source and the movement mechanism by the coupling/releasing unit after the one or more cleaning mechanisms are moved to the first height.

20. A non-transitory computer readable storage medium storing a program causing a computer to execute a control method of a printing apparatus that includes a cleaning unit including a plurality of cleaning mechanisms configured to clean a printing head ejecting a liquid, each of the plurality of cleaning mechanisms scanning in a predetermined direction while contacting the printing head,
a movement mechanism configured to move each of the plurality of cleaning mechanisms between a first height in contact with the printing head and a second height no in contact with the printing head,
a driving source of the movement mechanism, and
a coupling/releasing unit configured to perform coupling/releasing between the driving source and the movement mechanism, the control method comprising the steps of:
moving one or more cleaning mechanisms of the plurality of cleaning mechanisms to the first height by the movement mechanism coupled with the driving source; and
releasing coupling between the driving source and the movement mechanism by the coupling/releasing unit after the one or more cleaning mechanisms are moved to the first height.
